(19) United States
(12) Patent Application Publication
(10) Pub. No.: US 2009/0187719 A1
(43) Pub. Date: Jul. 23, 2009

(54) DATA BACKUP METHOD FOR LOGICAL VOLUME MANAGER

(75) Inventors: Hai-Ting YAO, Tianjin (CN); Jian-Fei WANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/016,152

(22) Filed: Jan. 17, 2008

(51) Int. Cl. G06F 12/16

(52) U.S. Cl. 711/162; 711/E12.103

(57) ABSTRACT

A data backup method for logical volume manager (LVM) is used for backup the original data in the LV when adding newly data into a logical volume of the LVM. Before adding a snapshot volume, a new storage space is created. The LVM writes the data to be altered in the logical volume into the new storage space. The LVM then renames the logical volume to the snapshot volume, and names the new storage space to the logical volume. According to the method, reading and writing times of the physical disk can be reduced, so as to quicken backup efficiency.

### BACKGROUND OF THE INVENTION

1. Field of Invention

The present invention relates to a data backup method for computer storage equipment, and more particularly to a data backup method applied to a logical volume manager.

2. Related Art

In order to safely and effectively save data information in a computer, many data information storage technologies are proposed in the past, such as redundant array of independent disks (RAID), and logical volume manager LVM). For the LVM, a plurality of physical disks is integrated to serve as a same volume group, and then the volume group is divided into several logical volumes (LV)

A snapshot method is further provided in the LVM. The so-called snapshot is to provide a corresponding snapshot volume SV, and the snapshot volume SV is used to perform real-time backup on data information of a certain specific time in the logical volume LV. The snapshot volume SV performs the backup on rewritten data in the logical volume LV instead of performing total backup on all the data in the logical volume LV.

FIG. 1a shows a flow chart of the data backup of the logical volume and the snapshot volume. A logical volume is provided (step S110), and the logical volume respectively has a plurality of data. Adding a snapshot volume (step S120). New data is written into a cache memory (step S130). The data before alternation in the logical volume is read (step S140). The data before alternation is written into the snapshot volume (step S150). The new data is written from the cache memory into the logical volume (step S160).

In order to clearly illustrate operation manner of the logical volume and the snapshot volume, please refer to FIGS. 1b-1e. Firstly, a logical volume LV110 is created. In order to be convenient to illustrate mapping relation of the logical volume LV110 and the snapshot volume SV, here it is assumed that four groups of data, i.e., Data1₁1111, Data2₁1121, Data3₁1131, and Data4₁1141, those groups of data are saved in the logical volume LV110. Each parameter in the data Data Nₓ represents the x^{th} backup of the N^{th} batch of data in the logical volume LV110. The snapshot volume SV^{m} represents the snapshot volume of the m^{th} volume.

Next, a first snapshot volume SV₁120 is created. At this time, the logical volume LV110 does not have data transaction, so the first snapshot volume SV₁120 does not store the transaction data of the logical volume LV110, as shown in FIG. 1b. Data1₁1111 and Data4₁1142 in the logical volume LV110 are rewritten into Data1₂1112 and Data4₂1142. At the same time, the first snapshot volume SV₁120 respectively stores Data1₁1111 and Data4₁1141, as shown in FIG. 1c. In order to clearly illustrate the dependent position, please refer to arrow indication directions of each block data in the drawings.

A second snapshot volume SV₂130 is newly added, please refer to FIG. 1d, the manner of newly adding the snapshot volume is performing an action of adding the snapshot volume at fixed intervals. Next, Data2₁1121 and Data4₂1142 in the logical volume LV110 are rewritten, and then the transaction data of Data2₁1121 and Data4₂1142 in the logical volume LV110 is recorded to the second snapshot volume SV₂130, as shown in FIG. 1e.

In other words, the snapshot recording method of the LVM is that when the logical volume LV110 has the data transaction, the original data before the transaction of the logical volume LV110 is stored to the current latest snapshot volume SV. However, the backup process needs the following steps. The old data of the logical volume is read, the old data is written into the snapshot volume SV, and the new data is written into the logical volume. The method needs disk actions of reading once and writing twice. When a great quantity of data needs to be accessed, executing performance of the LVM is encumbered by frequent operation of the disk actions.

The action of resuming the data of the logical volume to the data when the snapshot is created is called rollback. When the logical volume LV110 intends to perform the rollback, it is necessary to read each data one by one in the snapshot volume SV, and to write the old data back to the corresponding positions in the logical volume LV110.

Referring to FIG. 2a, it is a flow chart of the rollback action of the conventional LVM. Select a latest snapshot volume (step S210). In the snapshot volume selected in step S210, the data dependent on the logical volume is made to overwrite the corresponding data in the logical volume (step S220), until the data in the snapshot volume is totally written into the logical volume. Delete the snapshot volume selected in step S210 (step S230). Next, step S210 is repeated, so as to select a next snapshot volume. Then, step S220 to step S230 are performed, until the rollback snapshot volume and the subsequently created snapshot volumes are deleted (step S240).

Referring to FIGS. 2b to 2f, schematic views of the rollback action performed by the conventional LVM are shown. In FIG. 2b, a logical volume LV110, a first snapshot volume SV₁ and a second snapshot volume SV₂ are included, in which the data of the logical volume LV110 depends on the second snapshot volume SV₂, and the data of the second snapshot volume SV₂ depends on the first snapshot volume SV₁. In other words, the relation between the newness degree of the data, the logical volume LV110 and snapshot volume SV is that the data in the logical volume LV110 is the latest data, the data saved in the second snapshot volume SV₂ takes second place, and the oldest data is saved in the first snapshot volume SV₁.

According to step S210, firstly, the newly generated snapshot volume is selected in the current snapshot volume, and the latest snapshot volume SV in FIG. 2B is the second snapshot volume SV₂. Data in the second snapshot volume SV₂ named Data 2₁ and Data 4₂ are overwritten to the data named Data2₂ and Data4₃ in the logical volume (corresponding to step S220). When all the data in the second snapshot volume SV₂ are overwritten to the logical volume, the second snapshot volume SV₂ is deleted (step S230). Next, steps S210 to 230 are repeated, and then the first snapshot volume SV₁ is selected. Data named Data 1₁, and Data 4₁ in the first snapshot volume SV₁ are overwritten to the data named Data1₂ and Data4₂ in the logical volume LV110 (corresponding to step S240). According to the LVM rollback, it can be known that each rollback action includes actions of reading once, writing once, and deleting once, so when the quantity of the logical volumes is excessively large, the time for the data rollback is prolonged.

### SUMMARY OF THE INVENTION

In view of the above problem, the present invention is mainly directly to provide a data backup method for a logical volume manager (LVM), which is capable of newly adding data to a logical volume in the LVM, and performing backup on original data of the added data in the logical volume.

The data backup method for LVM includes the following step. A. A snapshot volume is generated. B. The current logical volume is renamed to the snapshot volume. C. The snapshot volume generated in step A is renamed to the logical volume. D. The data is written to the logical volume renamed in step C.

In the backup method for LVM provided in the present invention, the reading and writing times of the physical disk are reduced, so as to increase the accessing performance of the LVM.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1a is a schematic flow chart of the conventional data backup;

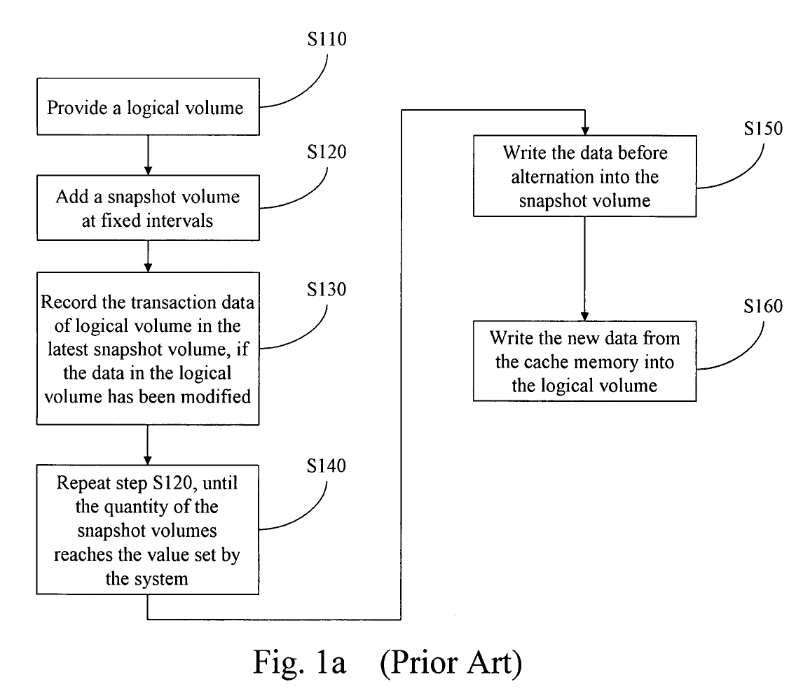

FIG. 1b is a schematic view of the generation of the first snapshot volume in the conventional art;

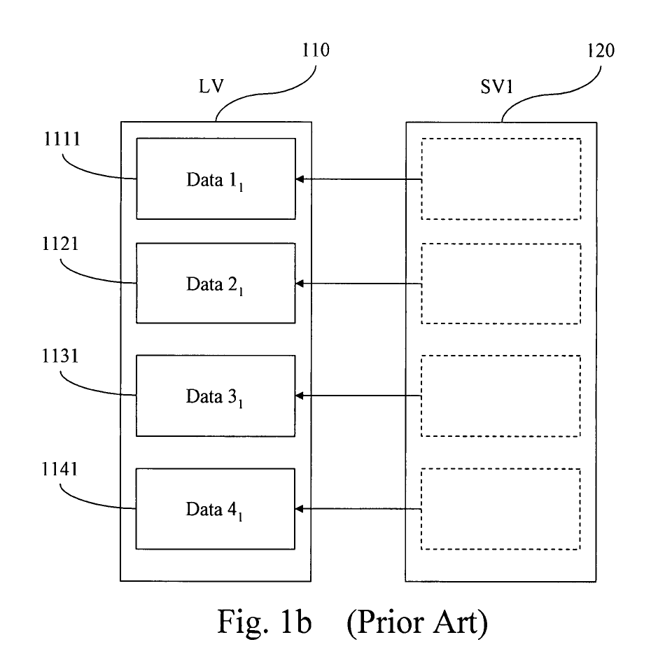

FIG. 1c is a schematic view of the data backup of the conventional first snapshot volume;

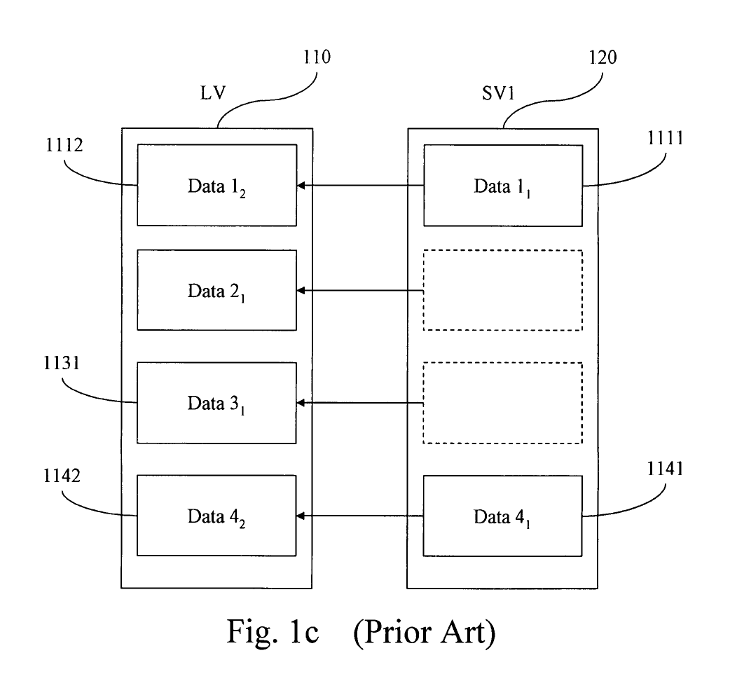

FIG. 1d is a schematic view of the generation of the second snapshot volume in the conventional art;

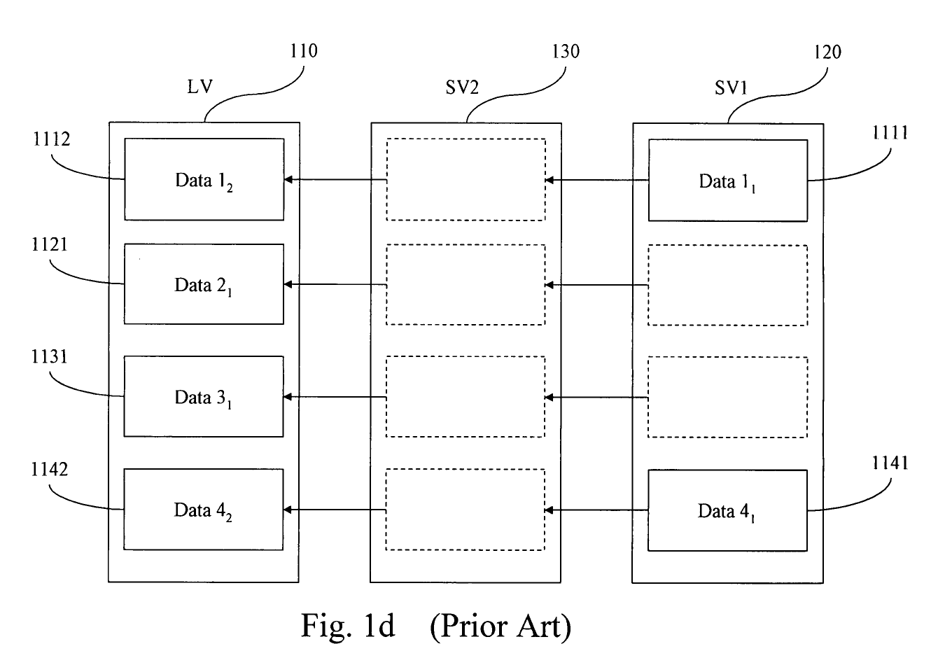

FIG. 1e is a schematic view of the data backup of the conventional second snapshot volume;

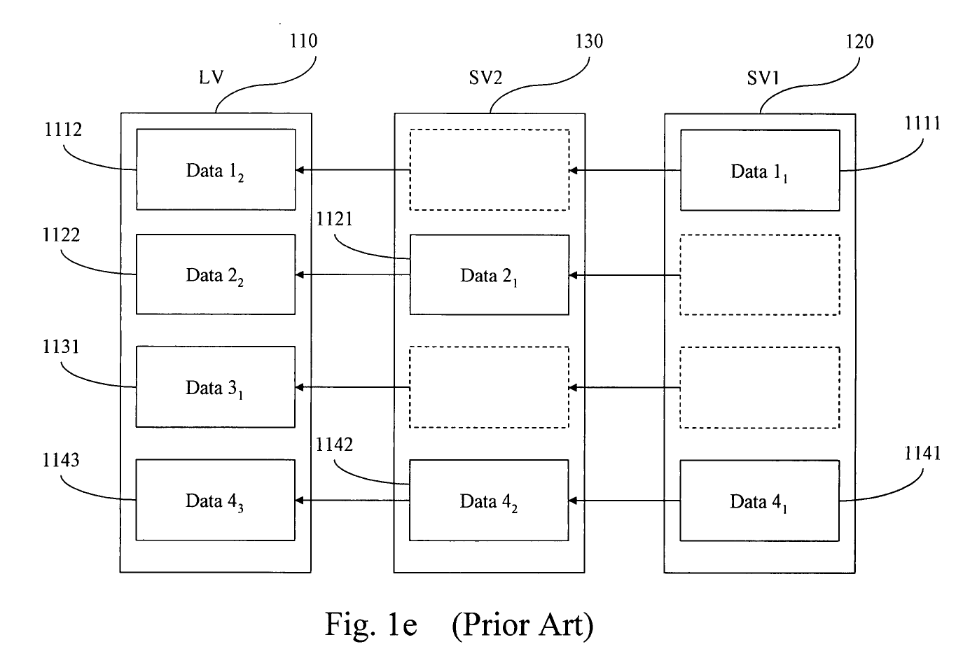

FIG. 2a is a flow chart of the rollback action of the conventional LVM;

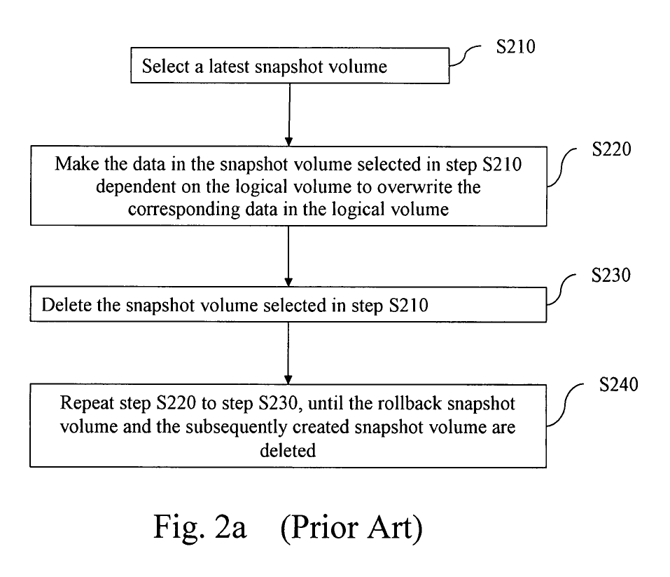

FIG. 2b is a schematic view of the rollback action performed by the conventional LVM;

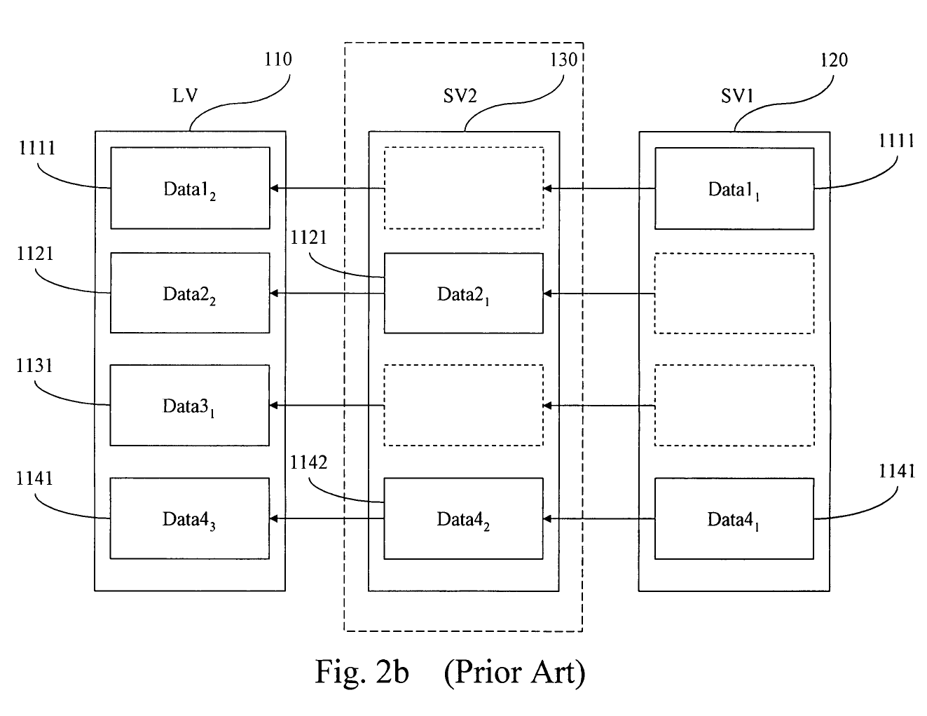

FIG. 2c is a schematic view of the rollback action performed by the conventional LVM;

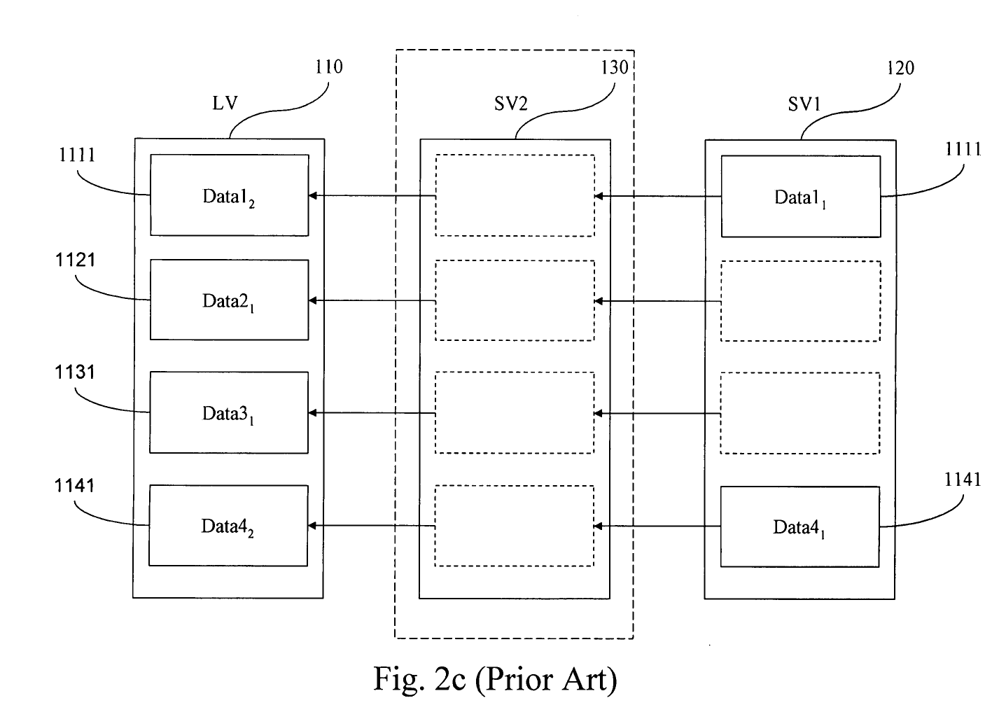

FIG. 2d is a schematic view of the rollback action performed by the conventional LVM;

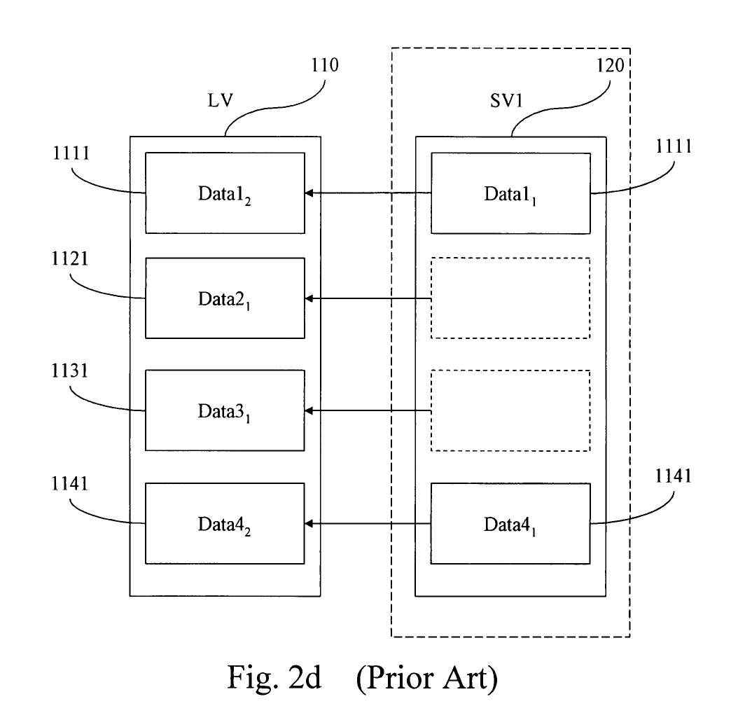

FIG. 2e is a schematic view of the rollback action performed by the conventional LVM;

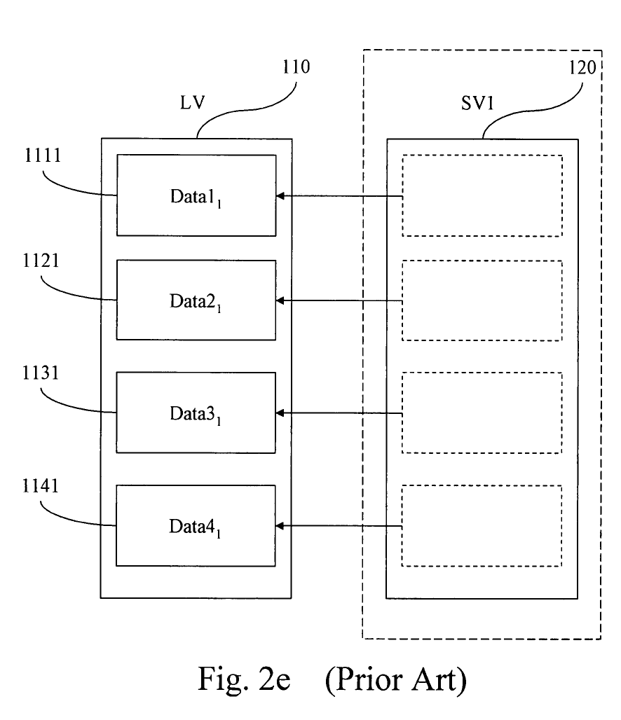

FIG. 2f is a schematic view of the rollback action performed by the conventional LVM;

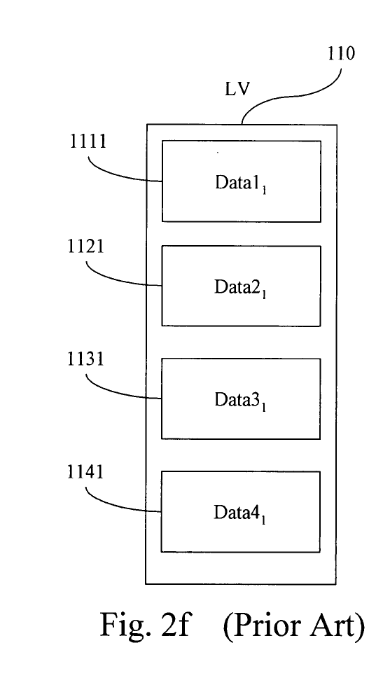

FIG. 3a is a flow chart of the data backup of the LVM of the present invention;

FIG. 3b is a schematic view of the generation of the first snapshot volume of the present invention;

FIG. 3c is a schematic view of the rename of the first snapshot volume and the logical volume of the present invention;

FIG. 3d is a schematic view of the backup data of the present invention;

FIG. 3e is a schematic view of the generation of the second snapshot volume of the present invention;

FIG. 3f is a schematic view of the rename of the second snapshot volume and the logical volume of the present invention;

FIG. 3g is a schematic view of the backup data of the present invention;

FIG. 4a is a schematic view of the flow of the data rollback of the present invention;

FIG. 4b is a schematic view of the data rollback of the LVM of the present invention;

FIG. 4c is a schematic view of the data rollback of the LVM of the present invention;

FIG. 4d is a schematic view of the data rollback of the LVM of the present invention; and

FIG. 4e is a schematic view of the data rollback of the LVM of the present invention.

### DETAILED DESCRIPTION OF THE INVENTION

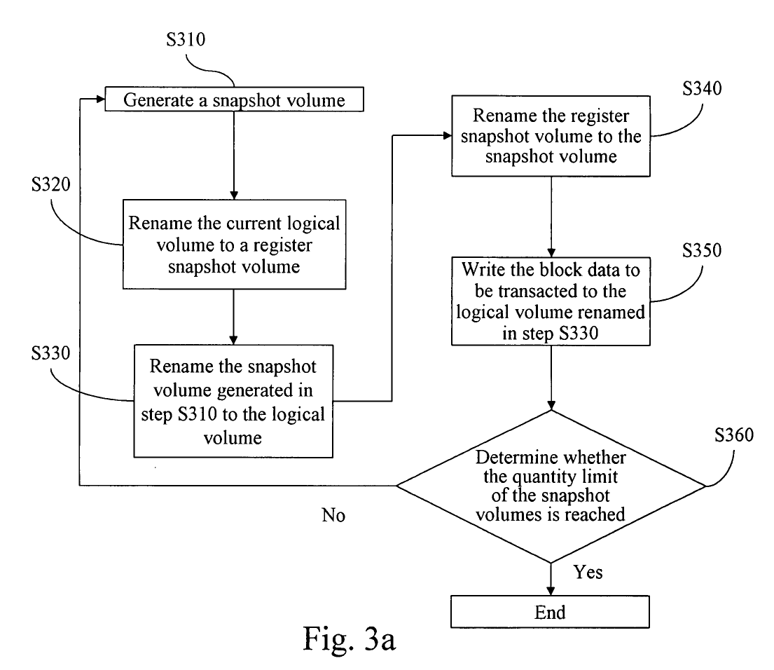

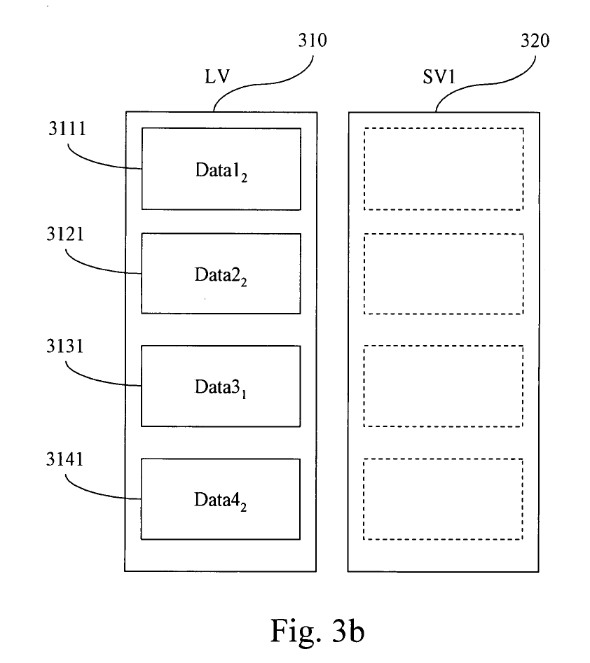

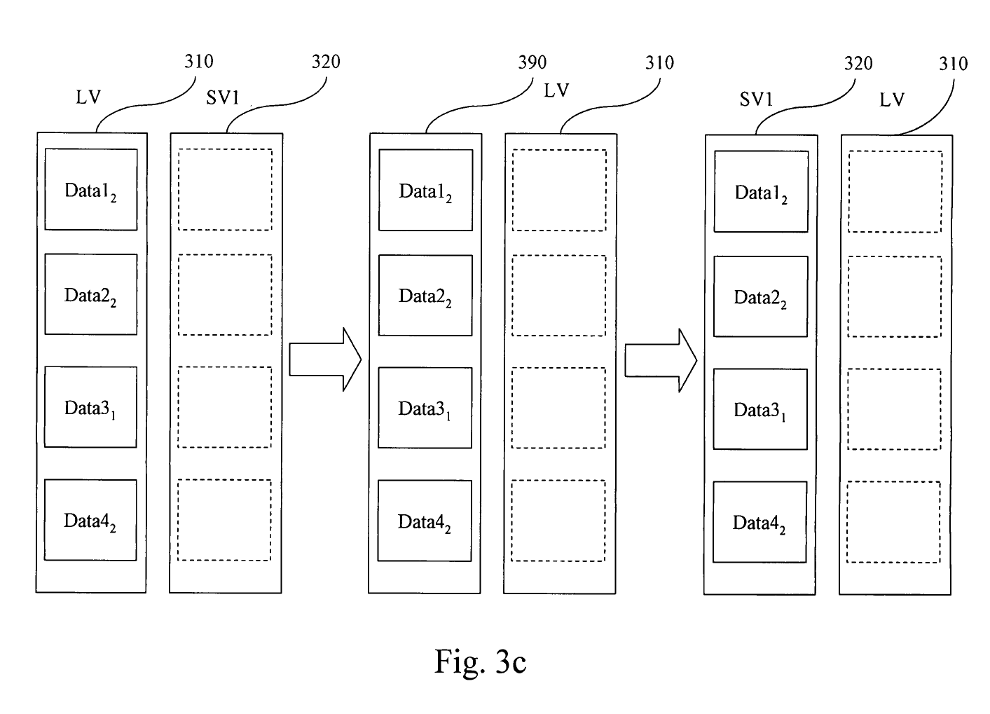

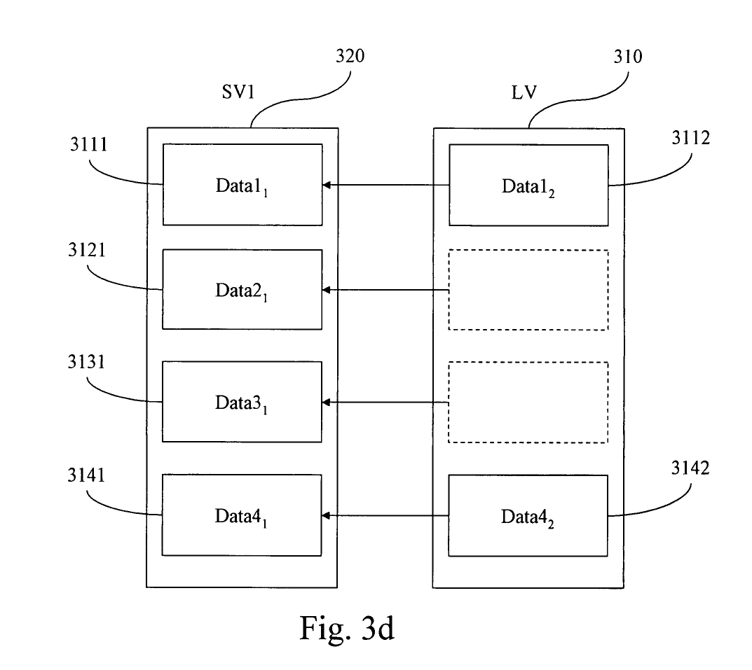

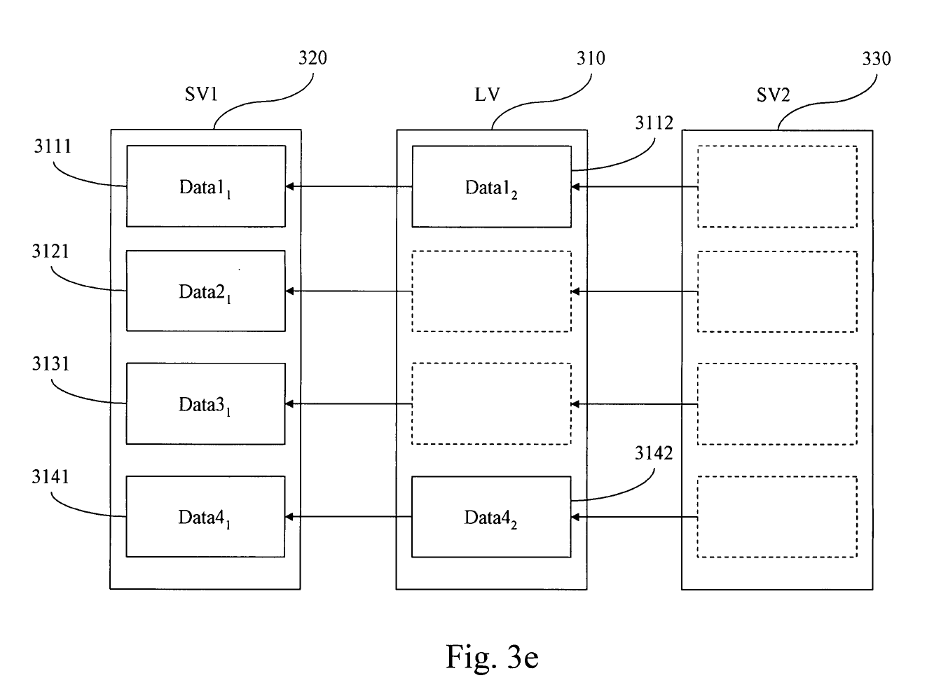

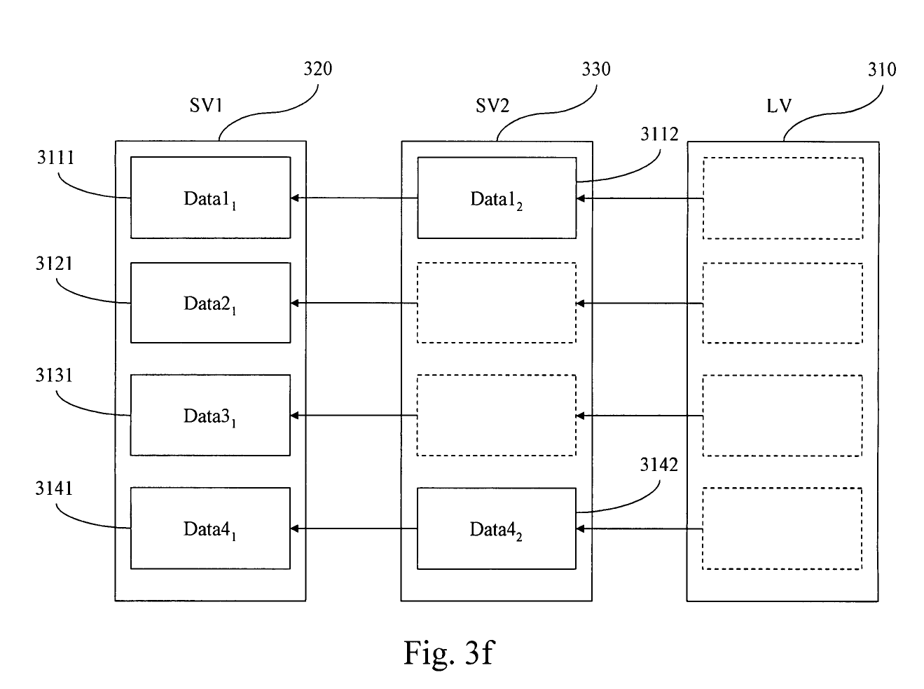

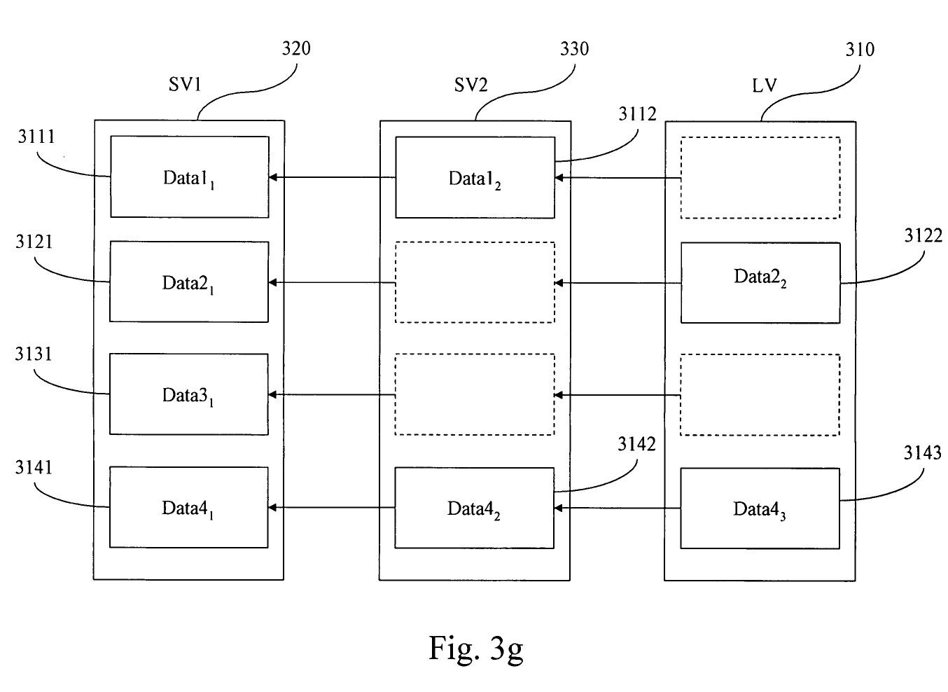

As shown in FIG. 3a, it is a flow chart of the data backup of the LVM of the present invention. Firstly, generating a snapshot volume (step S310), and the snapshot volume is used to record the altered data in a logical volume. Renaming the current logical volume to a register snapshot volume (step S320). Renaming the snapshot volume generated in step S310 to a logical volume (step S330). Renaming the temporal snapshot volume to a snapshot volume (step S340). The modified block data is written to the logical volume renamed in step S330 (step S350). And steps S310 to S350 are repeated, until the quantity of the logical volumes reaches the quantity set by the LVM (step S360). Definitely, the snapshot can also be created when it is necessary to perform backup operation on the logical volume data at any time.

In order to explain the operation process of the present invention more clearly, please refer to FIGS. 3b and 3c, schematic views of the generation and the rename of the snapshot volume of the LVM are shown. Firstly, a first snapshot volume SV₁320 is generated, it is assumed that four groups of data, i.e., Data1₁3111, Data2₁3121, Data3₁3131, and Data4₁3141, those groups of data are saved in the logical volume. Each parameter in the data Data Nₓ represents the x^{th} backup of the N^{th} batch of data in the logical volume LV 310. Here, the logical volume LV 310 does not have the data transaction, so the first snapshot volume SV₁ does not store the transaction data in the logical volume LV 310.

Next, the current logical volume is renamed to the register snapshot volume. The first snapshot volume SV₁320 generated in step S310 is renamed to the logical volume 310. Finally, the register snapshot volume 390 is renamed to the first snapshot volume SV₁ (corresponding to steps S320 to S340). It should be particularly noted that the data saved in the original logical volume LV310 is not moved to other volumes because of renaming. Similarly, if the data is saved in the snapshot volume SV, the data is not moved to other volumes.

In order to clearly illustrate dependent positions, please refer to the arrow indication directions of each data in FIG. 3d. Four groups of data, i.e., Data1₁3111, Data2₁3121, Data3₁3131, and Data4₁3141, are saved in the new first snapshot volume SV₁320. If it intends to modify Data1₁3111 and Data4₁3141 saved in the first snapshot volume SV₁320, in the present invention, the modified Data1₂3112 and Data4₂3142 are written into the dependent positions in the new logical volume LV 310 (corresponding to step S350).

Next, it is determined whether the quantity of the snapshot volumes SV reaches an upper limit of the set quantity in the LVM. The quantity of the snapshot volume SV is determined by the capacity of the physical disk. If it reaches the upper limit of the quantity of the snapshot volumes SV, the generation of the snapshot volume is stopped. If it does not reach the upper limit of the quantity of the snapshot volumes SV, the steps S310 to S350 are repeated. In this embodiment, two snapshot volumes are used as an example, so the LVM repeats the step S310 again to generate a second snapshot volume SV₂330, as shown in FIG. 3e, and the newly generated second snapshot volume SV₂330 is dependent on the original logical volume LV 310. Then, the step of renaming the second snapshot volume SV₂330 and the logical volume LV 310 is performed, as shown in FIG. 3f, it is a schematic view of the rename of the second snapshot volume and the logical volume of the present invention.

If it intends to modify the data named Data2₁3121 and Data4₂3142 in the first snapshot volume SV₁320, the modified data Data2₂3122 and Data4₃3143 are written into each data dependent position in the logical volume LV 310. After the backup action, the data named Data1₁3111, Data2₁3121, Data3₁3131, and Data4₁ are saved in the first snapshot volume SV₁320. The data named Data1₂3112 and Data4₂3141 are saved in the snapshot volume SV₂330. The data named Data2₂3122 and Data4₃3143 are saved in the logical volume LV 310. Referring to FIG. 3g, it is a schematic view of the dependent relation of the logical volume and each snapshot volume. In this embodiment, for each backup performed on the data, the physical disk only needs to read once or write once. In this embodiment, the rename time is shorter than the time of the writing operation of the physical disk, so the data backup time of this embodiment is shorter than the conventional data backup.

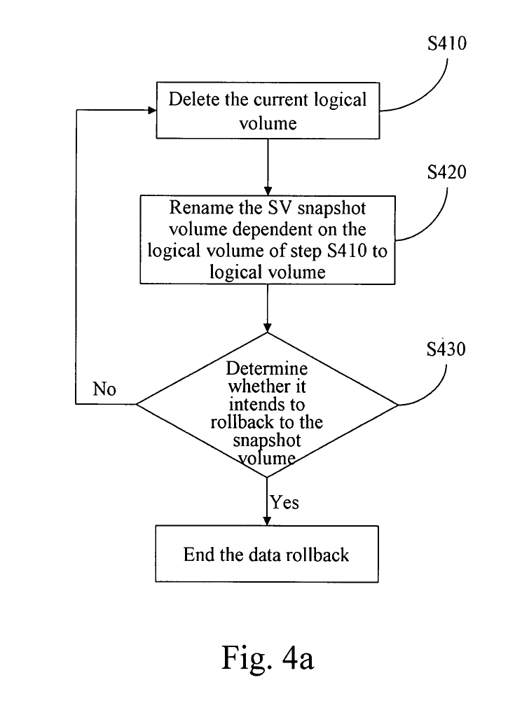

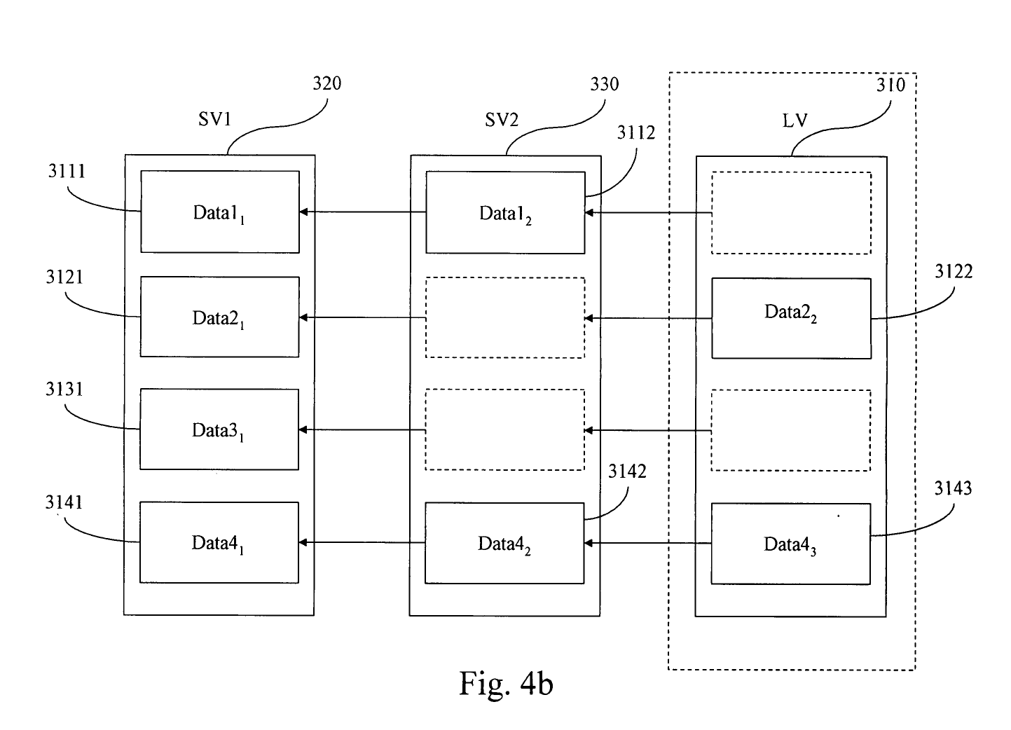

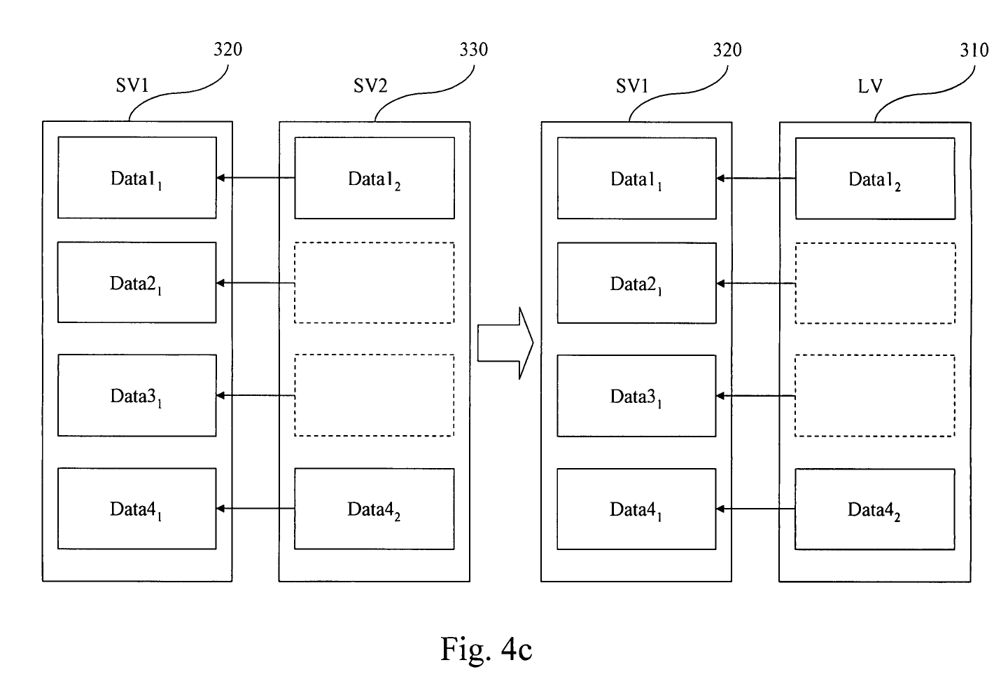

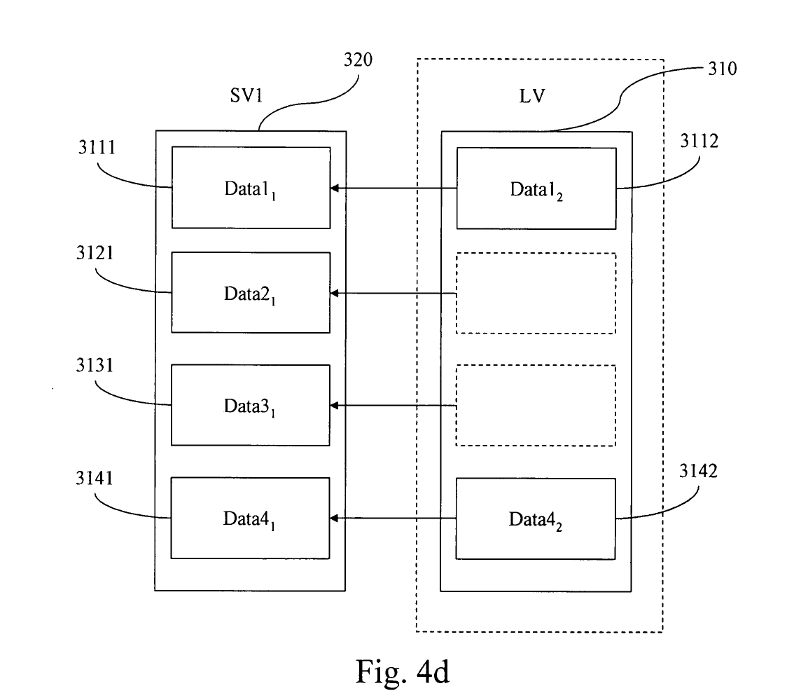

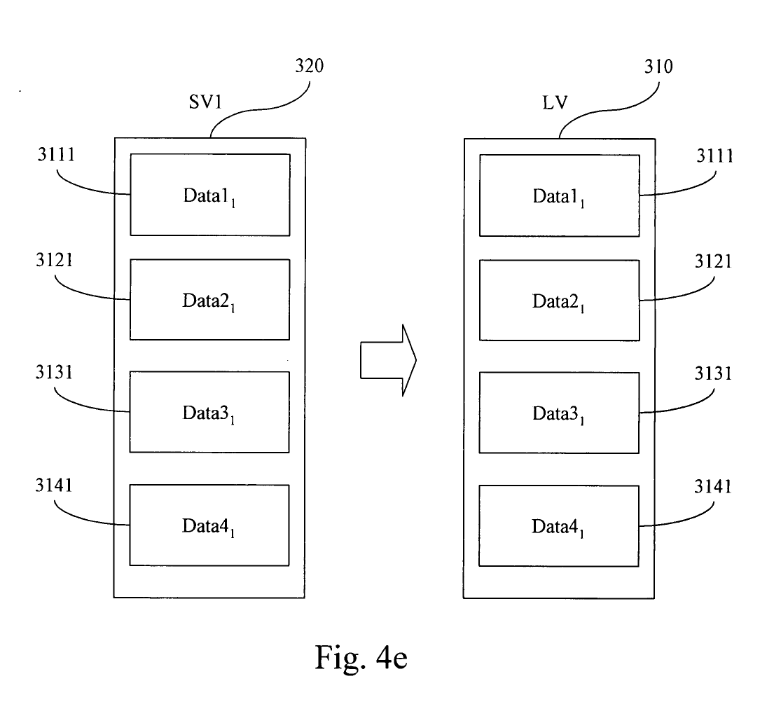

In addition, based on the backup data method of the present invention, the present invention further provides a data rollback method. For the detailed operation flow of the data rollback method, please refer to FIG. 4a. The current logical volume is deleted (step S410), and the logical volume is the logical volume set after the data backup. The snapshot volume dependent on the logical volume of step S410 is renamed to the logical volume (step S420). It is determined whether it intends to rollback to the snapshot volume (step S430). If it is the last logical volume LV310, the data rollback is end. If it is not the last logical volume LV310, step S410 is repeated, till one logical volume LV310 is remained.

According to the data rollback method, here for the schematic views of the detailed operation corresponding to each step, please refer to FIGS. 4b to 4e. Corresponding to step S410, according to the logical volume LV310 generated after the data backup, the logical volume LV310 is selected, and the logical volume LV310 is deleted, for example, the logical volume LV310 circled by dashed lines shown in FIG. 4b. Next, the second snapshot volume SV₂330 dependent on the deleted logical volume LV310 is renamed to the logical volume LV310 (corresponding to step S420), as shown in FIG. 4c. The logical volume LV310 is not the last one, so steps S410 to S420 are repeated. When the last logical volume LV310 is obtained, the action of the data rollback is finished.

As compared with the conventional data rollback, the data rollback of the present invention does not have the disk data moving action, and the rollback snapshot of the conventional art needs to perform several times of reading and writing actions, which depends on the data amount of the snapshot backup. In the present invention, it is only necessary to delete each snapshot volume SV, and finally the original data Data1₁, Data2₁, Data3₁, and Data4₁ can be obtained.

In the backup method for LVM of the present invention, the data backup/the data rollback is performed to reduce the times of the reading and writing of the physical disk, so as to improve the accessing performance on the LVM execution.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data backup method for a logical volume manager (LVM), wherein when a certain block data in a logical volume is modified, the data block before modification is backed up, comprising:
A. generating a snapshot volume;
B. renaming the current logical volume to a register snapshot volume;
C. renaming the snapshot volume generated in step A to a logical volume;
D. renaming the register snapshot volume to a snapshot volume; and
E. writing the modified block data into the logical volume renamed in step C.

2. The data backup method for an LVM as claimed in claim 1, wherein the backup method further comprises a data rollback step, and the data rollback step comprises:
a. deleting a current logical volume;
b. renaming a snapshot volume corresponding to the logical volume of step a to a logical volume; and
c. repeating the step a, until content of the logical volume is rolled back to the assigned snapshot volume.
